(19) United States
(12) Patent Application Publication
(10) Pub. No.: US 2012/0247093 A1
(43) Pub. Date: Oct. 4, 2012

(54) DISPLACEMENT ELEMENT

(75) Inventors: Frank Bartels, Hattingen (DE); Isam Tahhan, Kirchzarten (DE)

(73) Assignee: Bartels Mikrotechnik GMBH, Dortmund (DE)

(21) Appl. No.: 12/522,556

(22) PCT Filed: Jan. 10, 2007
(86) PCT No.: PCT/EP07/00169

§ 371 Date: Dec. 2, 2009

(51) Int. Cl. F15B 13/00

(52) U.S. Cl. 60/325

(57) ABSTRACT

The invention relates to a mechanical displacement element, which is provided by means of a displacement foil, capable of being configured as a miniature and has a hollow space that is configured such that a spatial arrangement and/or configuration of the displacement foil occurs by means of the supply and/or the removal of a liquid and/or gaseous medium into and/or from the hollow space. The displacement foil is disposed on an object, and/or is at least partially integrated in the object, such that a predetermined change of the spatial configuration of the object is occurs with a change of the spatial arrangement and/or configuration of the displacement foil.

The invention relates to a mechanical displacement element that is suitable to effect a change of the spatial arrangement and/or configuration of an object by interaction with further mechanical elements.

From the state of the art, a multitude of mechanical actuators is known that generate a mechanical movement under energy conversion, and that essentially comprise a energy conversion element that interacts with a displacement element. However, the known actuators can be provided only limited and with high development and production costs as a miniature as well, wherein particularly a miniaturized design of their displacement element and its arrangement can be provided only at significant production and assembly effort.

It is therefore desirable to provide a mechanical displacement element that is usable for many and diverse applications, which is extensively universally usable also when being provided as a miniature by far reaching minimization of design, production, and assembly efforts, and which is suitable of being fabricated in series production as well.

The problem is solved by the characteristics of the claims. Advantageous embodiments are mentioned in the sub claims and/or the subsequent description.

For this, it is shown in

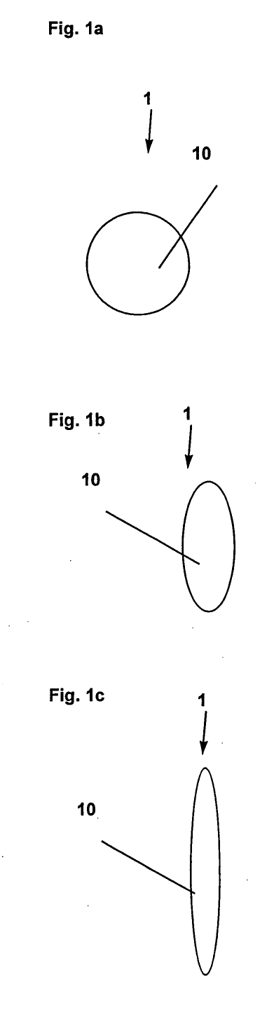

FIG. 1 a, b and c a schematic representation of a first embodiment of a displacement element according to the invention in a first, second, and third spatial arrangement;

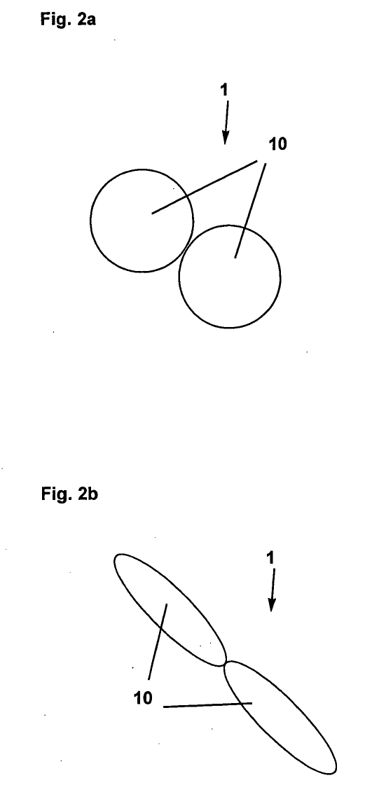

FIG. 2a and b a schematic representation of a second embodiment of a displacement element according to the invention in a first and second spatial arrangement;

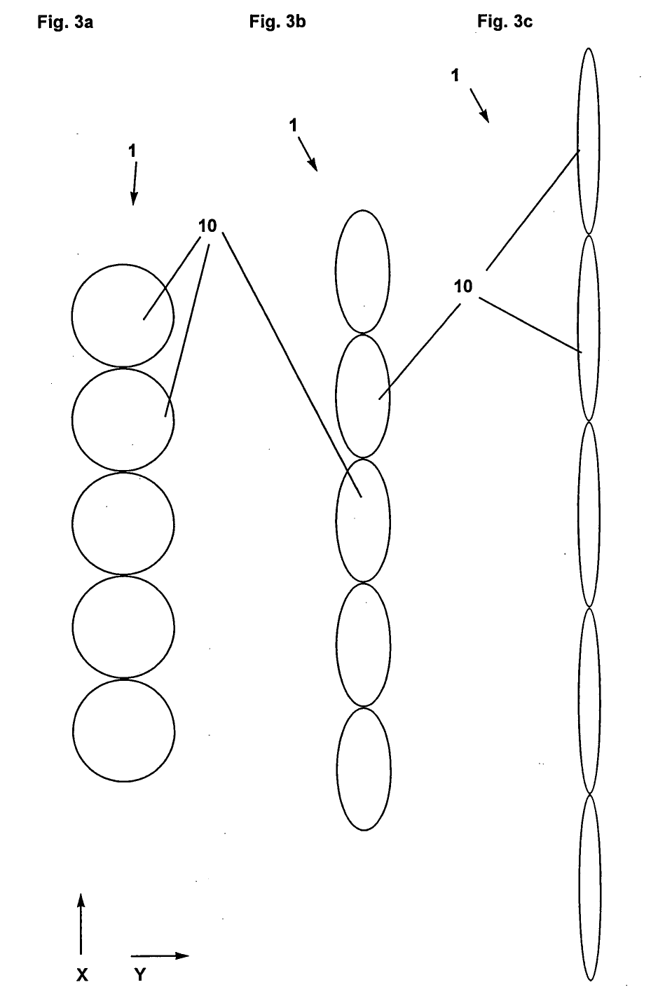

FIG. 3 a, b and c a schematic representation of a embodiment of a displacement element of a third embodiment according to the present invention in a first, second, and third spatial arrangement;

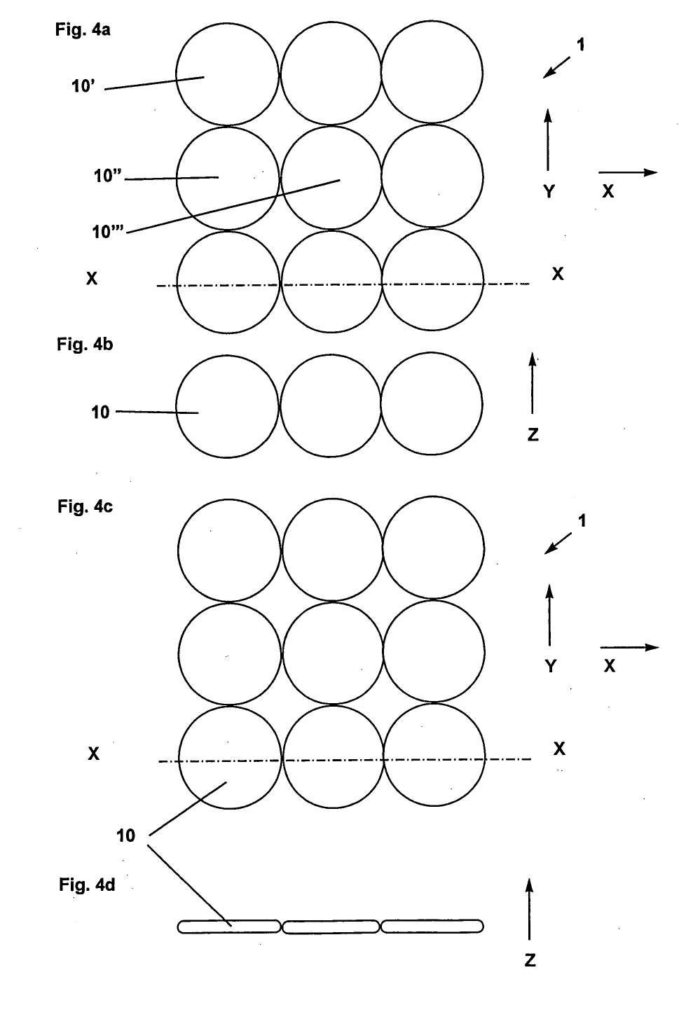

FIG. 4a a schematic representation of a displacement element according to a fourth embodiment of the present invention in a first spatial arrangement and FIG. 4b a cross section through the displacement element of FIG. 4a along the line X-X of FIG. 4a; and FIG. 4c the displacement element of FIG. 4a in a second spatial arrangement and FIG. 4d a cross section through the displacement element of FIG. 4c along the line X-X of FIG. 4c;

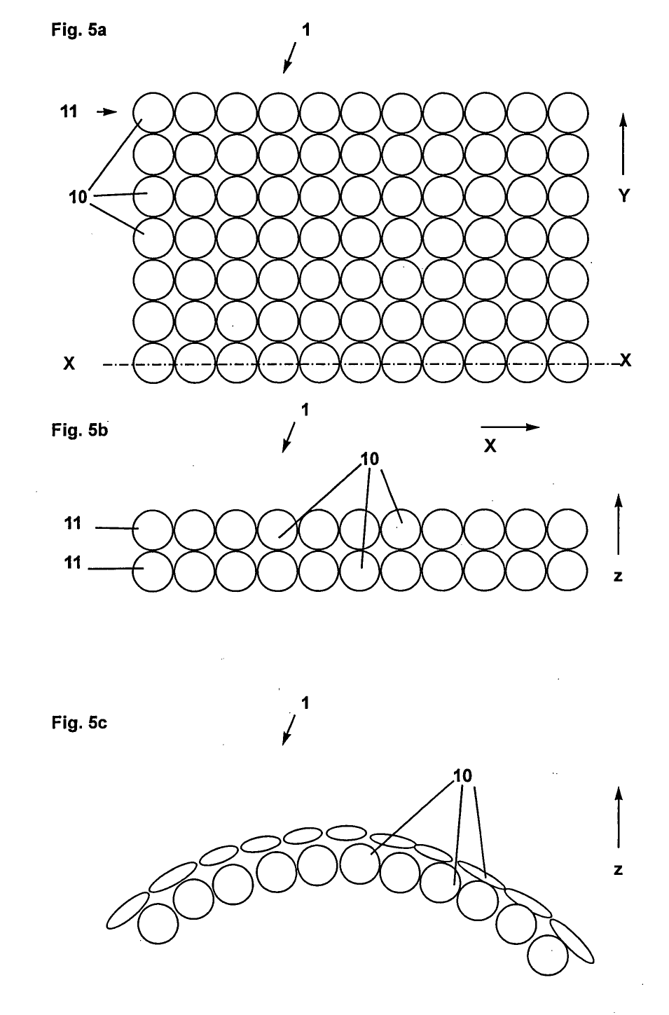

FIG. 5a a schematic representation of a top view of a fifth embodiment of a displacement element according to the invention in a first spatial arrangement; and FIG. 5b a cross section through the displacement element of FIG. 5a along the line X-X of FIG. 5a, and FIG. 5c the displacement element of FIG. 5b in a second spatial arrangement;

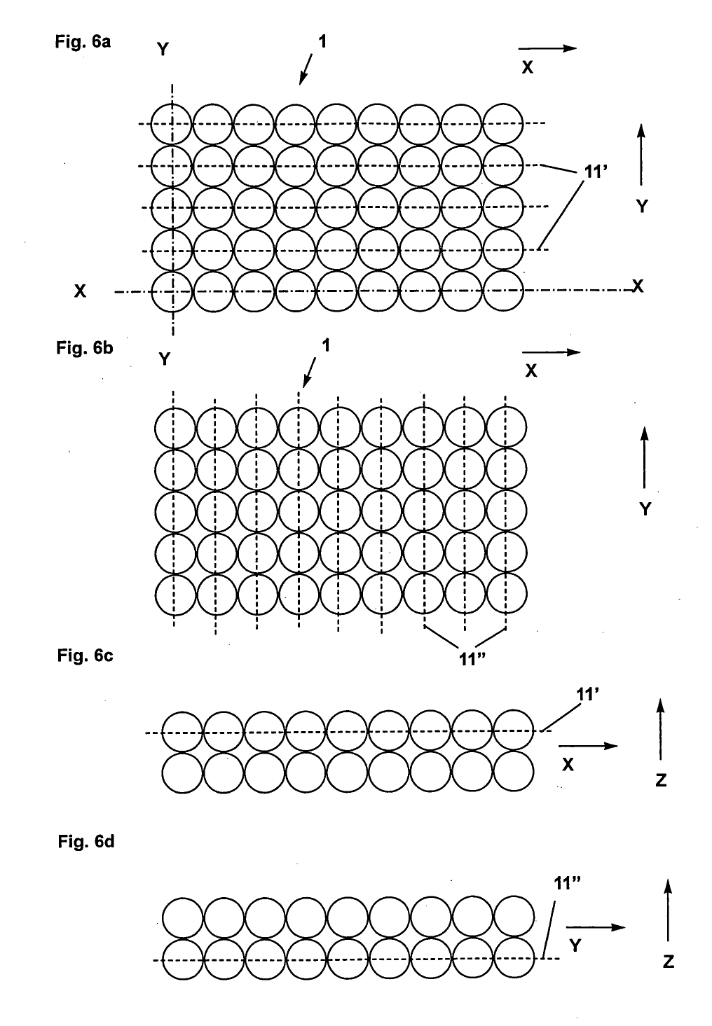

FIG. 6a a schematic representation of a sixth embodiment of a displacement element according to the present invention in a first arrangement from above; FIG. 6b the displacement of FIG. 6a from below; FIG. 6c a cross section through the displacement element of FIG. 6a along the line X-X of FIG. 6a; and FIG. 6d a cross section through the displacement element of FIG. 6a along the line Y-Y of FIG. 6a;

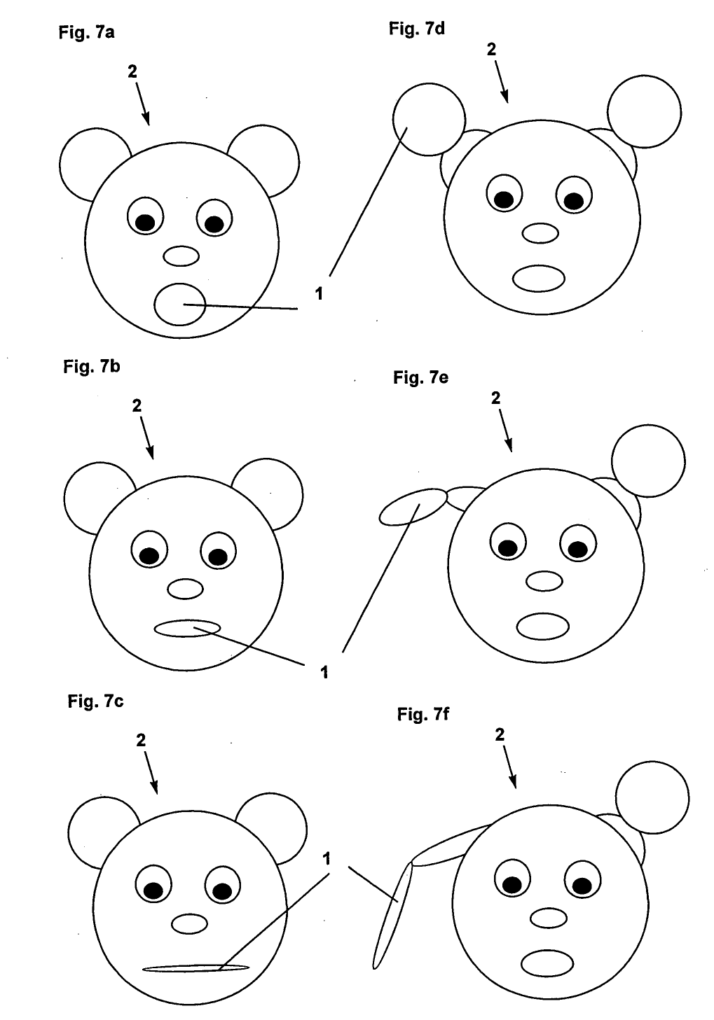

FIG. 7a, b, and c a schematic representation of a displacement element according to the invention that is arranged at an object in a first, second, and third spatial arrangement; and FIG. 7d, e, and f a further schematic representation of a displacement element according to the invention that is arranged at an object in a first, second, and third spatial arrangement;

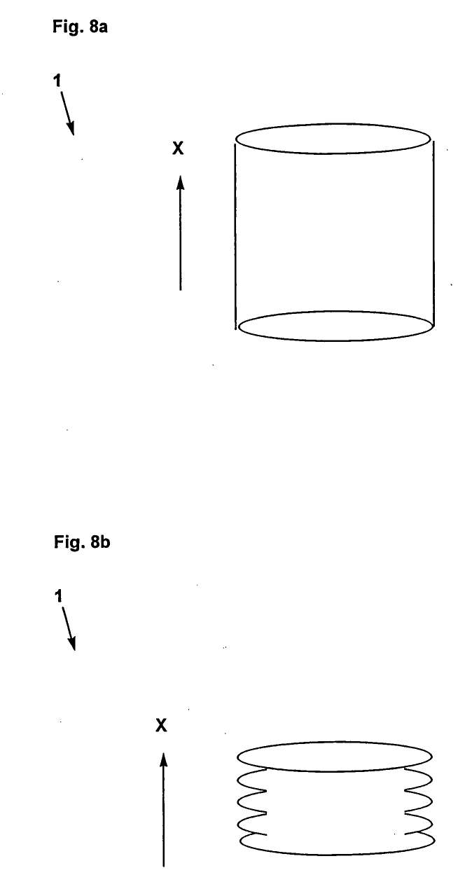

FIG. 8a and b a schematic representation of a displacement element according to a seventh embodiment of the present invention in a first and second spatial arrangement;

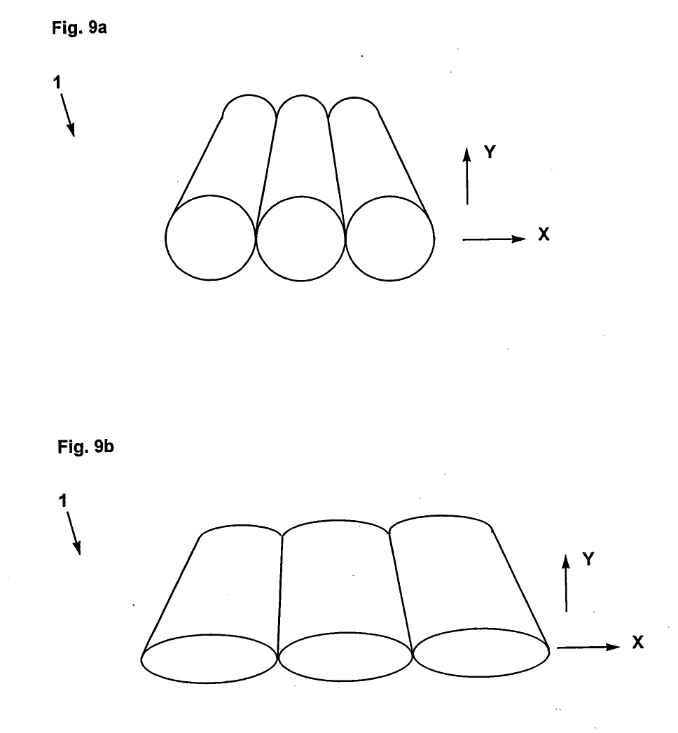

FIG. 9a and b a schematic representation of a displacement element according to an eighth embodiment of the present invention in a first and second spatial arrangement; and

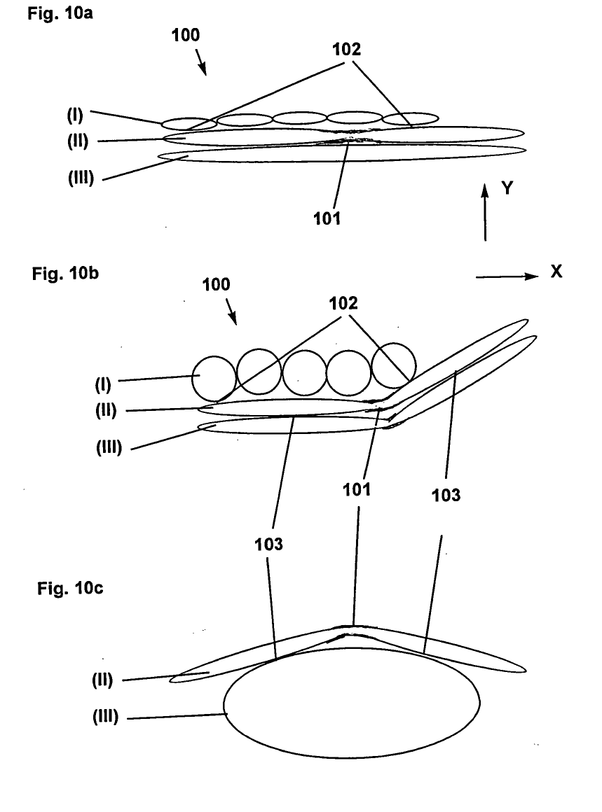

FIG. 10a, b, and c a schematic representation of a displacement element according to a ninth embodiment of the present invention in a first, second, and third spatial arrangement;

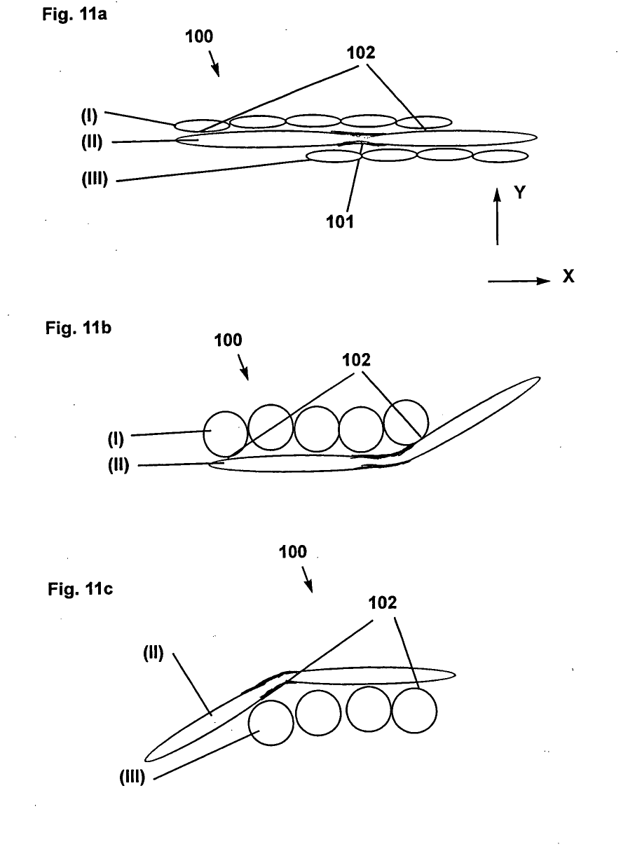

FIG. 11a, b, and c a schematic representation of a displacement element according to a tenth embodiment of the present invention in a first, second, and third spatial arrangement;

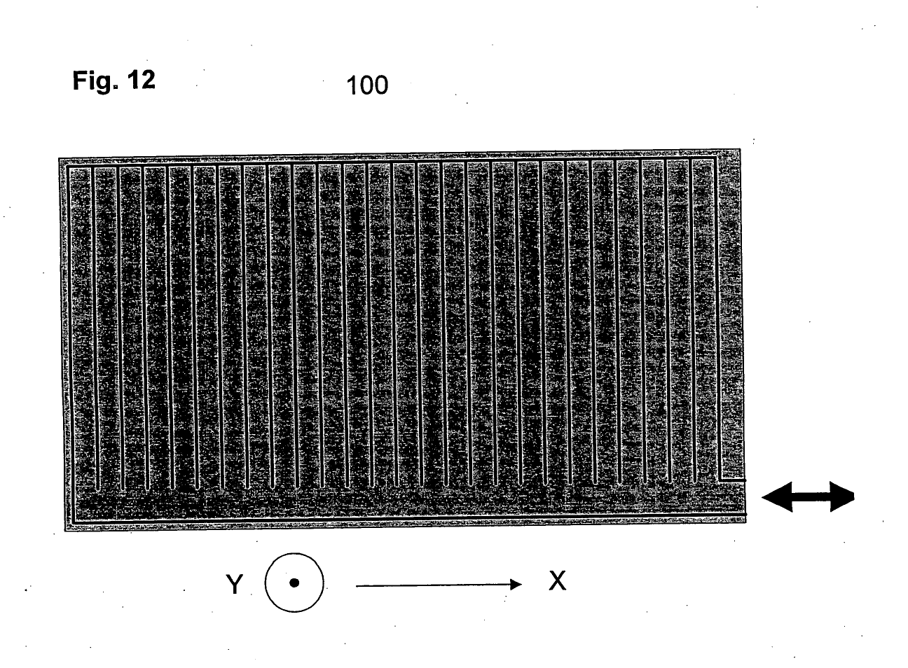

FIG. 12 a schematic top view of a displacement element of an eleventh embodiment of the present invention;

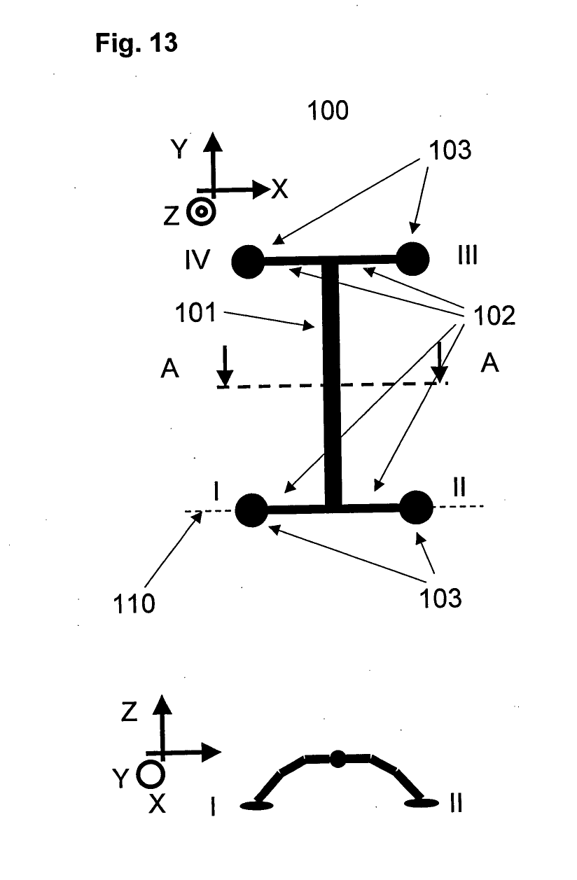

FIG. 13 a schematic representation of a displacement element of a twelfth embodiment of the present invention in a first, spatial arrangement in a top view together with a cross section through the line A-A of the top view;

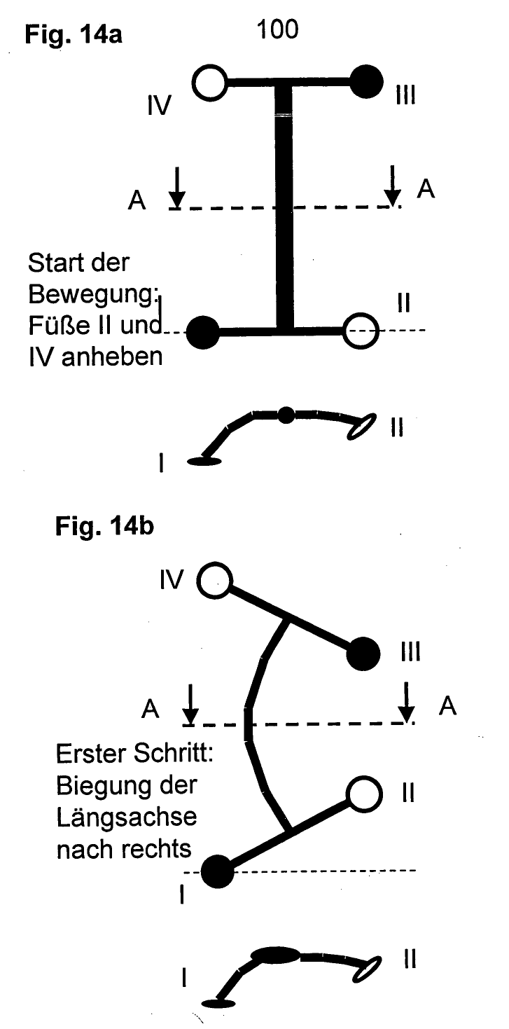

FIG. 14 a andb respectively a schematic representation of the displacement element of FIG. 13 in a first and second spatial arrangement in a top view together with a cross section through the line A-A of the top view;

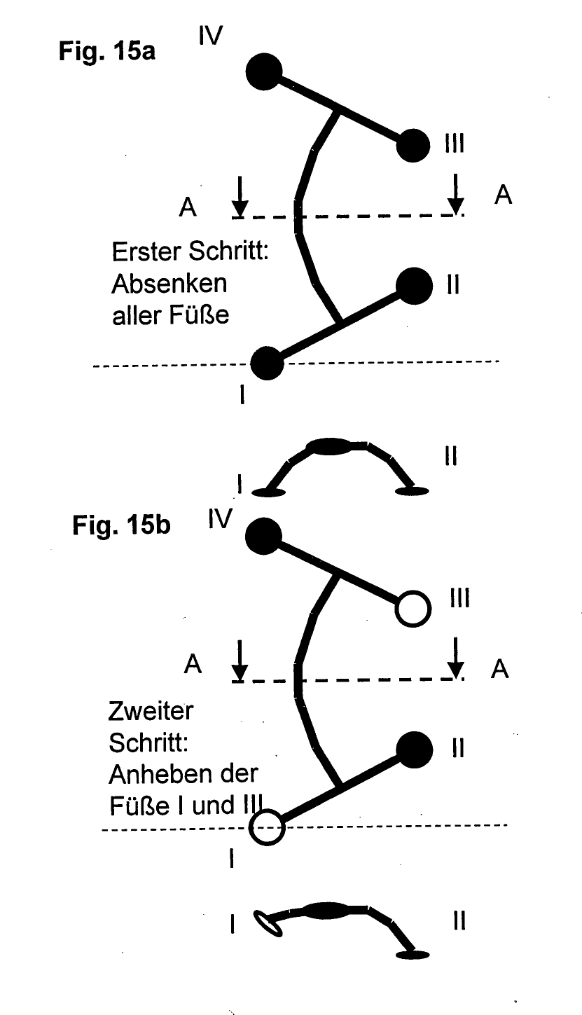

FIG. 15 a and b respectively a schematic representation of the displacement element of FIG. 13 in a third and fourth spatial arrangement in a top view together with a cross section through the line A-A of the top view; and

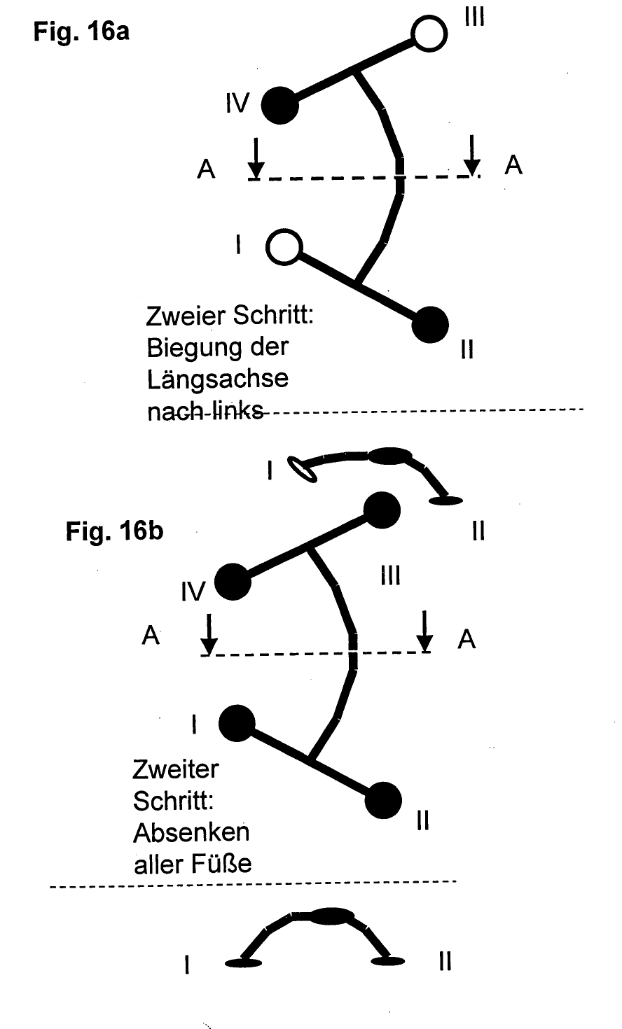

FIG. 16 a and b respectively a schematic representation of the displacement element of FIG. 13 in a fifth and sixth spatial arrangement in a top view together with a cross section through the line A-A of the top view.

The operating principle of a displacement element according to the invention can be described as follows:

An essentially hollow body has a first predetermined shape in the unloaded state. The body is elastically deformable (stretchable) in one or two spatial directions, while it is manufactured to be elastically, but not stretchable into the remaining spatial direction(s).

The hollow body's interior is pressurized in order to transform the body from the first predetermined shape of the unloaded state into a second shape (b) of the loaded state. The transport medium for the (working-) pressure can be provided by liquid as well as gas, or by a mixture of both. The source of the pressure can be a conventional or a miniaturized pump, thermal expansion, expansion due to explosion or chemical reactions, etc. Crucial is a change of pressure relative to the pressure during the first predetermined state of shape. Therefore, generation of a lower than the first pressure (under pressure, vacuum) is basically possible as power source for the change of shape of said body. Adequately, the change of the external pressure while keeping the internal pressure unchanged can be used as well.

Due to the change (here: increase) of the internal pressure (or the relation between internal and external pressure, respectively), the body tends to extend itself along all spatial directions into which it can elastically stretchy deform itself. Together with the extension goes the respective, desired change of shape. Within certain limits, the latter follows the value of the present internal pressure, so that arbitrary intermediate states can be realized between the predetermined end configurations. The end configuration can be defined either by means of constructive limitation of the working pressure (valves, maximal pumping pressure), or by constructive configuration change characteristics (end stops; slack, but non-stretchable strings, that become tensioned just upon reaching the end position).

A displacement element 1 according to the invention particularly comprises a displacement foil 1 with a hollow space 10 which is configured such that by means of the supply and/or the removal of a liquid and/or gaseous medium into and/or from the hollow space 10, a spatial arrangement and/or configuration of the displacement foil 1 occurs, wherein the displacement foil 1 is disposed on an object 2, and/or is at least partially integrated in the object 2, such that a predetermined change of the spatial configuration of the object 2 occurs upon a change of the spatial arrangement and/or configuration of the displacement foil 1.

The displacement element 1 preferably is configured and/or provided in a malleable, but not elastic, foil like material such that a predetermined change of the spatial arrangement and/or configuration the object 2 by means of filling and/or emptying of the hollow space 10 is reversible, and wherein the wall thickness of the displacement foil 1 remains mostly constant.

According to a preferred embodiment of the present invention, the displacement 1 and/or the object 2 can be configured to be single-pieced.

According to another preferred embodiment, the displacement element 1 can be arranged at and/or close to the surface of the object 2, and/or partially be integrated into the object 2.

An advantageous embodiment of a displacement element 1 according to the invention can comprise a multitude of first hollow spaces 10 that are connected to each other, such that a first hollow space row is provided, wherein the hollow spaces 10 of the first hollow space row can advantageously be arranged subsequent to each other, approximately linear in a first direction X.

Suitably, the hollow spaces 10 that are filled with the medium can approximately be sphere-shaped and arranged such that a contraction of the displacement foil 1 in the first direction X occurs and an extension of the displacement foil 1 occurs in a second direction Y upon a filling of the hollow spaces 10; and such that an extension of the displacement foil 1 in the first direction X occurs and a contraction of the displacement foil 1 occurs in a second direction Y upon emptying of the hollow spaces 10, wherein the first direction X and the second direction Y advantageously are arranged approximately perpendicular to each other.

A displacement element according to the invention can further advantageously comprise a multitude of hollow space rows that are adjacently arranged and that are connected to each other and form a first layer, and a multitude of such layers can be arranged adjacently in tiers. The multitude of hollow space rows can suitably comprise differently configured displacement foils and/or functional intermediate layers, wherein particularly advantageous, a joint structure can be provided.

FIG. 1a shows in a first spatial arrangement a schematic representation of a first embodiment of the present invention with a displacement element 1 which is provided by means of a displacement foil 1 made from a suitable material (e.g. plastic) in a first spatial arrangement. The displacement foil 1 comprises a hollow space 10 and is configured such that by means of the supply and/or the removal of a liquid and/or gaseous medium into and/or from the hollow space 10, a change of the spatial arrangement and/or configuration of the displacement foil 1 occurs. The displacement foil 1 of FIG. 1a is exemplarily and advantageously configured such that the displacement foil 1 is approximately configured sphere-shaped upon an entirely filled hollow space 10.

The displacement foil 1 is further configured and chosen from a suitable material such that the displacement foil 1 takes an approximately two dimensional shape upon complete emptying of the medium from the hollow space 10. A displacement foil 1 according to the invention can further be configured and/or chosen from a suitable material such that an extension or contraction of the displacement foil 1 in a first spatial direction occurs and further a contraction or extension of the displacement foil 1 in a second spatial direction occurs upon filling and/or emptying of the hollow space 10, wherein the first spatial direction and the second spatial direction suitably are vertically arranged.

Further, a displacement foil element 1 is provided by means of an above described displacement foil 1 by which a multitude of further embodiments of the invention can be built in similar and/or different configurations, being subsequently described.

The FIG. 2a shows a displacement element 1 according to the invention, according to a second embodiment of the present invention, comprising two adjacently arranged displacement foil elements 1 according the above described first embodiment of the present invention, whose hollow spaces 10 are suitably connected to each other. FIG. 2a shows the second embodiment of the invention in a first arrangement with entirely filled hollow spaces 10, and FIG. 2b shows the second embodiment of the invention in a second arrangement with partially filled hollow spaces 10.

According to the invention, the contraction- or extension effect upon emptying or filling of the hollow spaces 10 is increased relative to the first embodiment by the advantageously adjacent arrangement of at least two displacement foil elements 1 according to FIGS. 1a to c.

The above described effect according to the invention is further made use of by the third embodiment as schematically shown in FIGS. 3a-c, wherein a multitude of identically made displacement foil elements 1 are subsequently arranged in a row approximately in a first direction X, and configured such that the hollow spaces 10 are connected to each other. Herein, FIG. 3a shows a schematic third embodiment in a first arrangement with entirely filled hollow spaces 10, and FIG. 3b shows the embodiment of FIG. 3a in a second arrangement with partially filled hollow spaces 10, and FIG. 3c shows the third embodiment of FIGS. 3a and 3b with nearly completely emptied hollow spaces 10, wherein in particular, the extension of the displacement foil 1 in X-direction of the third arrangement of FIG. 3c is significantly larger than of the first arrangement of FIG. 3a, and wherein at the same time, the extension of the third arrangement of FIG. 3c in the Y-direction (approximately perpendicular to the X-direction) is comparatively slightly reduced in relation to the first arrangement of FIG. 3a.

FIG. 4a shows a fourth embodiment of the present invention in a first arrangement with entirely filled hollow spaces 10, wherein a multitude of displacement foil elements 1 are adjacently arranged in a plane that is defined by the directions X and Y such that the hollow spaces 10 are suitably connected to each other. As an example, the schematic representation of the fourth embodiment of FIG. 4a comprises nine displacement foil elements whose hollow spaces 10 can exemplarily and suitably be connected to each other in such a respective way that each hollow space 10 is connected to all hollow spaces 10 of the respectively adjacently arranged displacement foil elements. The hollow space 10′ of FIG. 4a is therefore suitably connected to two hollow spaces of its adjacently arranged displacement foil elements, and thus, the hollow space 10″ is connected to the hollow spaces of its three adjacently arranged displacement foil elements, and the hollow space 10′″ is therefore suitably connected to the hollow spaces of its four adjacently arranged displacement foil elements.

FIG. 4b shows a cut view through the fourth embodiment of the invention of FIG. 4a along the line X-X of FIG. 4a, according to which a displacement foil 1 according to the invention according to a fourth embodiment is essentially arranged in a plane (X-Y), and is extended comparatively lesser perpendicular to this plane in a third Z-direction.

FIG. 4c shows a top view on the fourth embodiment of the invention of FIG. 4a in a second arrangement with partially emptied hollow spaces 10, and FIG. 4d shows the second arrangement of FIG. 4c in a cut view along the line X-X of FIG. 4c.

With the adjacent arrangement of display foil elements according to the invention according to the fourth embodiment of a displacement foil 1 it is advantageously achieved that upon filling and emptying of the hollow spaces 10, the extension of the displacement foil 1 remains almost constant in a first and second direction X and Y, whereas a contraction or extension, respectively, only occurs in a third direction Z.

FIG. 5a shows a fifth embodiment of the invention in a first arrangement, wherein a multitude of displacement foil elements is adjacently arranged according to the first embodiment of the invention in a plane defined by the directions X and Yin a first displacement foil layer 11 according to the invention, and wherein at least two such displacement foil layers 11 are adjacently arranged in tiers. FIG. 5a shows a top view on the fifth embodiment of the present invention in a first arrangement with entirely filled hollow spaces 10, and FIG. 5b shows a cut view through the fifth embodiment of the invention in the first arrangement of FIG. 5a along the line X-X of FIG. 5a, and FIG. 5c shows the cut of FIG. 5b in a second arrangement, wherein one of the both displacement foil elements 11 has partially emptied hollow spaces 10. In the fifth embodiment of the invention, the first an second displacement foil layer 11 can be configured identically or at least very similar and/or differently, and the displacement foil elements with the hollow spaces 10 can have an identical shape and be fabricated of identical material. The material of the layers or the configuration and shape of the displacement foil elements can also be different depending of the desired change of the spatial position and arrangement of the displacement foil 1 which is realized by means of filling or emptying of the layers, respectively.

FIG. 6a shows a schematic representation of a displacement foil 1 of a sixth embodiment of the invention in a first arrangement from above, and FIG. 6b shows the embodiment of FIG. 6a from below, and FIG. 6c shows a cross section through the embodiment of FIG. 6a along the line X-X of FIG. 6a, and FIG. 6d shows a cross section through the embodiment of FIG. 6a along the line Y-Y of FIG. 6a. The sixth embodiment of the present invention essentially corresponds to the fifth embodiment of the present invention described above in connection with FIG. 5b, therefore referring to the according description. Further, in the sixth embodiment of the present invention, the hollow spaces 10 of the upper displacement foil layer 11 are respectively connected to each other in first rows 11′ along the X-direction, and on the other hand, the hollow spaces 10 of the lower layer are also connected to each other in second rows 11″, and they are approximately arranged perpendicular to the first rows 11′ of the upper layer in Y-direction. In the drawing, the connection of the hollow spaces 10 is respectively shown by a dashed line.

Further, the hollow spaces 10 of adjacent first and second rows 11′ and 11″ are respectively isolated from each other. By means of the previously described advantageous arrangement of the upper and lower layer and their formation in first 11′ and second 11″ connected rows of hollow spaces 10, a particularly simple and efficient change of the spatial arrangement of the displacement foil 1 which occurs similar to the third embodiment of the invention as described above is achieved in particular with regard to the plane that is defined by X and Y by the mutual emptying or filling of the hollow spaces 10 of the upper and/or lower layer.

It is clear that more than two displacement foil layers 11 can be arranged above each other as well. E.g., at least a first layer 11 of the sixth embodiment can be combined with at least one layer of the fifth embodiment of the invention, and that e.g. the first direction X of the sixth embodiment and the second direction Y of the sixth embodiment can be arranged in another angle with respect to each other, such as e.g. 60 or 45 degrees.

FIGS. 7a, b and c show an advantageous arrangement of a displacement foil 1 according to the invention at an object 2 using the example of a toy, wherein particularly advantageous, e.g. a mimic of a toy doll can be controlled by means of arrangement of the displacement foil 1 close to and/or at the surface of the object 2. FIGS. 7d, e, and f show a further advantageous embodiment of a displacement foil 1 according to the invention at an object 2, also using the example of a toy, wherein the displacement foil 1 is at least partially arranged inside the object 2 such that the object 2 can perform a motion by means of suitable control of the displacement foil 1.

A displacement element 1 according to the invention with a displacement foil 1 according to the invention has been described above exemplarily with the help of approximately sphere shape designed hollow spaces. FIG. 8 a and b show a schematic representation of a displacement element 1 in a seventh embodiment of the present invention in a first and second spatial arrangement, wherein the displacement element 1 of FIG. 8 approximately comprises a cylindrical hollow space, and wherein it changes its spatial arrangement and formation essentially in a direction X upon supply/discharge of a liquid or gaseous medium. Herein, FIG. 8a shows a essentially filled displacement element 1 with according spatial extension in X direction which substantially corresponds to the cylinder axis, and FIG. 8b shows an essentially emptied displacement element 1 with a corresponding dilatation in the X direction.

FIG. 9a and b show a schematic representation of a displacement element 1 according to an eighth embodiment of the present invention in a first and second spatial arrangement, wherein the displacement element 1 according to the invention comprises a multitude of cylinder elements that are arranged in a plane and that can have cylindrical hollow spaces which can be connected with each other. FIG. 9 schematically and exemplarily shows three cylinder elements that are arranged in a row, wherein it is clear that a multitude of cylinder elements can be arranged following each other in a plane, and that the arrangement of the multitude of cylinders in a plane suitably can be varied as well, so that e.g. star shaped or ring shaped cells or object develop. Because of the special arrangement and formation of the cylinder elements of the displacement element 1 of FIG. 9, the spatial arrangement and formation of the displacement element in direction of the axis of the cylinder elements does not change upon filling of the hollow spaces or emptying of the hollow spaces, respectively. Instead, a shortening occurs upon filling of the hollow spaces perpendicular to the axis of the cylinders and in the plane defined by the cylinders, and a spatial extension occurs as well perpendicular to the axis of the cylinders, and perpendicular to the plane defined, as shown in FIG. 9a. FIG. 9b shows a displacement element 1 which is emptied with regard to the filled state of FIG. 9a, with the corresponding extension in X direction, and shortening in Y direction.

It is clear that also a multitude of displacement elements 1 according to the eighth embodiment of the present invention can be spatially arranged above each other, so that the change in Y direction is increased.

FIGS. 10a, b, and c show a schematic representation of a displacement element according to a ninth embodiment of the present invention in a first, second, and third spatial arrangement. The displacement element of FIG. 9 comprises a first layer I with a displacement foil 1 having a multitude of hollow spaces that are connected with each other and that are approximately sphere shaped, and a third layer III with a displacement foil 1 with only one hollow space which can also be designed sphere shaped or cylindrical, and furthermore a second layer II which comprises a joint structure, and which is arranged sandwich like between the first I and the third III layer in such a way that upon filling and/or emptying of the multitude of the hollow spaces of the first layer I or of the hollow space of the third layer III, a movement of the joint of the second layer II occurs in Y direction. Suitably, the second layer II comprises two oblong elements that are connected via a suitable joint 101 with each other, and that are connected with the first I and third III layer at suitable locations 102 and 103. FIG. 10a shows the displacement element 100 according to the invention with an empty first and second layer I and II, wherein the first I, the second II, and the third III layer are arranged flat above each other.

FIG. 10b shows the displacement element 100 of FIG. 10a with a filled first layer I, wherein the multitude of approximately sphere shaped or cylindrical displacement elements experiences an extension in Y and a shortening in X direction, and wherein the joint 101 of the second layer II, the element of the second layer II that extends over the first layer I swings over the joint 101 in Y direction. It is clear that herein, the not filled third layer III which is connected with both elements of the second layer II, also correspondingly swings in Y direction. FIG. 10c shows the displacement element 100 according to the invention with a filled layer III, wherein a representation of the first layer I was omitted for the sake of simplicity and clarity. The filled layer III shortens relative to its emptied state in X direction and thickens in Y direction, wherein the both displacement elements of the second layer II correspondingly swing around the joint 101 in Y direction.

It is clear that a similarly functional displacement element 100 can also be provided with a second layer II having at least one joint and at least two displacement elements that are moveably attached to the joint, wherein the layer II can be arranged sandwich like between two layers I very similar to each other, as depicted in FIG. 11.

FIGS. 11a, b, and c show a schematic representation of a displacement element according to a tenth embodiment of the present invention in a first, second, and third spatial arrangement according to the previously described ninth embodiment of FIG. 10, wherein FIG. 11a shows an unfilled and therefore not displaced and flat state, whereas in the state of FIG. 11b, the first layer I is filled and therefore shortened, and the element of the second layer II which protrudes the first layer I is directed around the joint 101 in Y direction. FIG. 11c shows an accordingly filled state of the third layer III which is designed similar to the first layer I here, and which is arranged off-centre in relation to the first layer I and the joint 101 in such a way that the other of the both elements of the second layer II protrudes over the third layer III and is accordingly directed along the joint 101 in Y direction.

In the following, a method according to the invention for the production of a displacement element 1 according to an embodiment of the present invention is described under exemplary reference to the embodiment of FIG. 9. Suitably, a layer as described in FIG. 9b can e.g. be joined by means of laser welding, gluing, friction welding, etc., from two halves of FIG. 9 (upper and lower side) fabricated by injection moulding or hot embossing. Firstly, the shape corresponds to the relaxed basic shape (9a). A lid-and/or bottom area of the cylinders from FIG. 9 close by means of suitable techniques preferably already used in the prior joining step. The open end is connected to the device that provides the filling medium (e.g. a pump).

A further method for fabrication according to the invention comprises joining of two foils along parallel panels between which accordingly unjoined areas remain. In this way, oblong hollow spaced develop that transform into a cylindrical shape upon pressurizing (FIG. 9a). An axial stretching is not possible, since the foils are flexible, but not stretchable. In FIG. 12, such a setup is schematically shown in a displacement element according to the invention according to an eleventh embodiment of the present invention. The grey area shows the top view onto the foils, wherein the black lines represent the connections between the both foil layers. The double arrow indicates the flow of the filling medium which is supplied and discharged e.g. laterally through a defined opening.

FIGS. 13 to 16 show an exemplary combination according to the invention of displacement elements 1 that are suitably arranged and connected to each other in such a way that an object 2, 100 that moves along on four legs is provided.

FIG. 13 shows a schematic representation of a displacement element 1 according to the invention of a twelfth embodiment of the present invention in a first, spatial arrangement in a top view together with a cross section through the line A-A of the top view in the passive state with a longitudinal axis 101, from whose ends leg joints 102 respectively extend, and at which feet elements 103 are arranged.

FIG. 14 a and b respectively show a schematic representation of the displacement element of FIG. 13 in a first and second spatial arrangement in a top view together with a cross section through the line A-A of the top view, wherein the start of a motion, or the first step with the bending of the longitudinal axis 101 and lifted feet elements 103 (II and IV) is depicted, respectively.

FIG. 15 a and b respectively show a schematic representation of the displacement element of FIG. 13 in a third and fourth spatial arrangement in a top view together with a cross section through the line A-A of the top view, wherein a first step of the motion with lowering the feet element 103 (II and IV), or a second step with bending of the longitudinal axis 101 and lifted feet elements 103 (I and III) is depicted, respectively.

FIG. 16 a and b respectively show a schematic representation of the displacement element of FIG. 13 in a fifth and sixth spatial arrangement in a top view together with a cross section through the line A-A of the top view, wherein a third step of the motion with lifting the feet element 103 (III and I), or a third step with bending of the longitudinal axis 101 and lowered feet elements 103 (I and III) is depicted, respectively.

According to the invention and to FIGS. 13 to 16, an object 2, 100 is constructed from displacement elements according to the first to the eleventh, and in particular, the ninth or tenth embodiment of the present invention, wherein in particular, the elements longitudinal axis 101, leg joints 102, and feet elements 103 are provided from displacement foils 1 according to the present invention. Such an object 2, 100 which is, according to the invention, put together from several displacement foils, can move forward in direction of its longitudinal axis 101 e.g. by means of suitably arranged and switched displacement foils 1. The object 2, 100 suitably comprises the following elements:

A longitudinal axis 101, preferably a bimorphic displacement element 1 which is capable of bending around the Z-axis in positive (right) and negative (left) direction. A multitude of at least three monomorphic leg joints 102; monomorphic displacement elements which can bend around the Y-axis in one direction, and at whose ends stabilizing feet 103 (I, II, III, and IV) are respectively arranged.

A complete motion sequence can be provided in a subsequent survey of FIGS. 13 to 16:

Firstly, two diagonally opposite feet 103 (e.g. II and IV) lift off from the ground according to FIG. 14. The main joint 101 herein bends to the right, so that the feet II and IV that float in the air leap forward, while the feet II and I that rest on the ground serve for the support. Subsequent to this, as depicted on FIG. 15a, all feet 103 (I, II, III, and IV) are again lowered onto the ground, and subsequent to this, as depicted in FIGS. 15b and 16a, the other two feet 103 (I and III) are lifted, wherein the main joint 101 bends in the opposite direction, and the feet 103 that are located in the air leap forward. Subsequent to this, all feet 103 are lowered as depicted in FIG. 16b, whereupon the previously described motion sequence can start all over again.

In the FIGS. 13 to 16, the starting point is indicated by a dashed line 110; the object 2, 100 continuously moves forward in direction +Y and therefore further away from the starting line. Further, in the top view in the drawings, a lowered foot is depicted by a filled, and a lifted foot is depicted by an empty circle.

Naturally, a reverse motion can be effected as well by reversion of the previously described motion pattern. Furthermore, different curve radii are possible by different developments of the right- or left bend of the main joint 101. If e.g. the right bend is significantly stronger developed than the left bend, the object 2, 100 gradually describes a right curve, and vice-versa.

It should further be mentioned that the time in which one respective pair of feet 103 is in the air must be measured such that during the bending of the main axis 101 that follows the lifting, the object 2, 100 remains substantially parallel to the ground and does not fall over to the one or the other side.

It should further be mentioned that according to FIGS. 13 to 16, a previously described object 2, 100 according to the invention can be altered with e.g. further connection elements or fixed connection elements by means of further motion sequences, joint arrangements, and leg numbers not described here by usage of the object according to the invention, namely the combination of displacement foils 1, which perform motions around the Z- and the Y-axis and which have feet 102 attached to their ends.

In particular, a previously described displacement foil or a displacement element 1, respectively, according to one of the first to the twelfth embodiment of the present invention can be manufactured also in miniature by usage of common micro techniques, so that it is therefore suitable for being used at very small objects 2 as well.

It is clear that the displacement elements according to the invention according to the fist to the twelfth embodiment of the present invention can suitably be altered, wherein comb like structures can be built up according to the seventh and/or eighth embodiment of the invention e.g. from a multitude of cylindrical and arranged apart from each other displacement elements.

It is also clear that the displacement elements according to the invention can also suitably be combined with each other according to the first to the tenth embodiment of the present invention.

In order to stay with the aforementioned example of a toy, an accordingly miniaturized developed displacement foil 1 can e.g. control the mimic and/or motion of an also very small toy figure.

It is clear that a displacement element 1 according to the invention is not restricted to the aforementioned example of a toy, but that it can be used in a wide variety of applications, such as e.g. in industrial robotics, or e.g. at a control and/or output device element of e.g. an electronic computer, e.g. a computer mouse, according to which the displacement foil 1 can also be controlled such that an arrangement and/or spatial formation of a computer mouse occurs depending on signals received from the computer and/or from the mouse.

According to the first to twelfth embodiment of the present invention and in particular, the ninth and tenth embodiment, a displacement element 1 according to the invention can be integrated into a mechanically operatable instrument and/or coupled with the instrument, so that it cooperates with an intended mechanical effect of the instrument in a synchronous or asynchronous manner, wherein in particular the mechanical effect of the instrument can be amplified and/or altered and/or complemented.

Such a mechanical instrument can further be e.g. a tool or a household appliance.

Such a mechanical instrument can e.g. be a keyboard of a computer or a telephone, wherein in particular, an operation of predetermined keys or key combinations can provide a spatial change of also predetermined keys or key combinations be means of a displacement element according to the invention.

1. Displacement element, comprising a displacement foil (1) with a hollow space (10), wherein
the hollow space (10) is configured such that by means of the supply and/or the removal of a liquid and/or gaseous medium into and/or from the hollow space (10), a change of the spatial arrangement and/or configuration of the displacement foil (1) occurs;
the displacement foil (1) is arranged on an object (2), and/or is at least partially integrated in the object (2), such that a predetermined change of the spatial arrangement and/or configuration of the object (2) occurs upon a change of the spatial arrangement and/or configuration of the displacement foil (1).

2. Displacement element according to claim 1, wherein:
the displacement foil (1) is configured and/or arranged such that the object (2) has a first predetermined arrangement and/or configuration when the hollow space (10) is entirely emptied, and has a second predetermined arrangement and/or configuration when the hollow space (10) is entirely filled.

3. Displacement element according to claim 2, wherein:
the displacement foil (1) is further configured such that the object (2) has at least a third predetermined arrangement and/or configuration when the hollow space (10) is partially filled.

4. Displacement element according to one of the pervious claims, wherein:
the displacement foil (1) is configured such that a predetermined change of the spatial arrangement and/or configuration the object (2) by means of filling and/or emptying of the hollow space (10) is reversible.

5. Displacement element according to one of the pervious claims, wherein:
the displacement foil (1) and/or the object (2) are configured to be single-pieced.

6. Displacement element according to one of the pervious claims 1 to 4, wherein:
the displacement foil (1) is integrated into the object (2), and/or the displacement foil (1) is arranged at and/or close to the surface of the object (2).

7. Displacement element according to one of the pervious claims 1 to 6, wherein:
the hollow space (10) comprises a multitude of hollow spaces (10) that are connected to each other, such that a first hollow space row (11′) is provided.

8. Displacement element according to claim 7, wherein:
the first hollow space row (11′) is arranged in a predetermined first direction (X), and a multitude of first hollow space rows (11′) are adjacently arranged in a first displacement foil layer.

9. Displacement element according to claim 8, wherein:
the first hollow space rows (11′) are configured such that a contraction of the displacement foil (1) in a first direction (X) and an extension of the displacement foil (1) in a second direction (Y) occurs upon a filling of the hollow spaces (10); and
an extension of the displacement foil (1) in the first direction (X) and a contraction of the displacement foil (1) in the second direction (Y) occurs upon an emptying of the hollow spaces (10), wherein:
the first direction (X) and the second direction (Y) are arranged approximately perpendicular to each other.

10. Displacement element according to one of the claims 1 to 9, wherein:
the displacement foil (1) further comprises a multitude of second hollow spaces (10) that are connected to each other and that are arranged in a predetermined second direction (Y), such that a second hollow space row (11″) is provided, and a multitude of the second hollow space rows (11″) is adjacently arranged in a second displacement foil layer, and at least a first and a second displacement foil layer (11′, 11″) are arranged in tiers.

11. Displacement element according to one of the previous claims, wherein the displacement element comprises
a first layer (I) with a displacement foil (1) with a multitude of hollow spaces that are connected to each other and that are approximately sphere-shaped;
a third layer (III) with a displacement foil (1) with at least one hollow space;
a second layer (II) that comprises a joint structure and that is arranged sandwich-like between the first (I) and the third (III) layer, such that a movement of the joint of the second layer (II) occurs upon filling and/or emptying of the multitude of the hollow spaces of the first layer (I) or of the hollow space of the third layer (III).

12. Displacement element according to one of the previous claims, wherein:
at least three leg-like displacement foils (1, 102) are arranged at the ends of a bimorphic configured longitudinal axis (101), and the longitudinal axis (101) is also provided be means of a displacement foil (1), such that an object (100) is provided which executes a walking movement upon suitable control of the displacement foils (1, 102) and (1, 101).

13. Displacement element according to claim 12, wherein:
the object (100) further comprises feet (103) that are arranged at the ends of the leg-like displacement foils (1, 102).

14. Displacement element according to one of the previous claims, wherein:
the displacement foil (1) is configured as a miniature.

15. Displacement element according to claim 14, wherein:
the displacement foil (1) interacts with a pumping device that is configured as a miniature.

16. Displacement element according to one of the previous claims, wherein:
the predetermined change of the spatial arrangement and/or configuration of the object (2) provides a predetermined movement of the object (2).

17. Displacement element according to one of the previous claims, wherein:
the object (2) is a mechanically actuatable instrument, and the displacement element synchronously or asynchronously interacts with a mechanic of the object (2), wherein the mechanic of the instrument is amplified and/or modified and/or complemented.

18. Displacement element according to one of the previous claims, wherein:
the object (2) is a tool.

19. Displacement element according to one of the previous claims, wherein:
the object (2) is a household appliance.

20. Displacement element according to one of the previous claims, wherein:
the object (2) is a keyboard.

21. Displacement element according to one of the previous claims, wherein:
the object (2) is a toy figure.

22. Method for fabrication of a displacement element according to one of the claims 1 to 19, wherein:
a first and/or second crushable but not stretchable plastic foil is joined at predetermined positions by means of laser welding or gluing or friction welding, so that predetermined hollow spaces are provided.
